(19) United States
(12) Patent Application Publication
(10) Pub. No.: US 2015/0211444 A1
(43) Pub. Date: Jul. 30, 2015

(54) AFT COUNTER-ROTATING SHROUDED GEARED TURBOFAN

(71) Applicant: United Technologies Corporation, Hartford, CT (US)

(72) Inventors: Gabriel L. Suciu, Glastonbury, CT (US); Jesse M. Chandler, South Windsor, CT (US)

(21) Appl. No.: 14/592,950

(22) Filed: Jan. 9, 2015

Related U.S. Application Data
(60) Provisional application No. 61/933,345, filed on Jan. 30, 2014.

(51) Int. Cl. F02K 3/075; F02K 1/66; F02K 1/72

(52) U.S. Cl. CPC F02K 3/075; F02K 1/72; F02K 1/66; F05D 2260/40311

(57) ABSTRACT

A gas turbine engine comprises an outer shroud. An inner core housing is positioned radially inwardly of the outer shroud, and has a core engine including at least one compressor rotor and at least one turbine rotor. A combustor section is intermediate the at least one compressor rotor and the at least one turbine rotor. A fan turbine is positioned downstream of the at least one turbine rotor. The fan turbine drives a gear reduction to, in turn, drive at least one fan blade positioned radially inwardly of the outer shroud.

### CROSS-REFERENCE TO RELATED APPLICATION

This application claims priority to U.S. Provisional Patent Application No. 61/933,345, filed Jan. 30, 2014

### BACKGROUND OF THE INVENTION

This application relates to a gas turbine engine, wherein the fan for providing bypass air is mounted aft of a core engine.

Gas turbine engines are known and, typically, include a fan at a forward end of the engine delivering air into a bypass duct as propulsion air and also into a core engine. The air in the core engine is compressed in a compressor and delivered into a combustion section where it is mixed with fuel and ignited. Products of this combustion pass downstream over turbine rotors which, in turn, drive compressor rotors and a fan rotor to rotate.

Traditionally, a turbine rotor has rotated at a single speed with the fan rotor. This has been a limitation on the speed of the turbine rotor as the fan rotor cannot rotate at unduly high speeds. More recently, it has been proposed to include a gear reduction between a fan drive turbine and the fan rotor. This allows the fan rotor to rotate at slower speeds and allows the fan drive turbine rotor to rotate at higher speeds.

In addition, it has been proposed to include propellers driven by a turbine rotor in a gas turbine engine. These propellers have generally not been provided with a shroud and, thus, do not provide bypass air as in a typical geared turbofan engine as described above.

### SUMMARY OF THE INVENTION

In a featured embodiment, a gas turbine engine comprises an outer shroud. An inner core housing is positioned radially inwardly of the outer shroud, and has a core engine including at least one compressor rotor and at least one turbine rotor. A combustor section is intermediate the at least one compressor rotor and the at least one turbine rotor. A fan turbine is positioned downstream of the at least one turbine rotor. The fan turbine drives a gear reduction to, in turn, drive at least one fan blade positioned radially inwardly of the outer shroud.

In another embodiment according to the previous embodiment, the at least one fan blade is a pair of axially spaced fan rotors.

In another embodiment according to any of the previous embodiments, the pair of fan rotors rotate in opposed directions.

In another embodiment according to any of the previous embodiments, the core engine includes at least a pair of compressor rotors and at least a pair of turbine rotors. The fan turbine is a third turbine rotor.

In another embodiment according to any of the previous embodiments, an inlet to the core engine extends axially beyond an upstream end of the outer shroud.

In another embodiment according to any of the previous embodiments, a pitch change mechanism is associated with the at least one fan blade.

In another embodiment according to any of the previous embodiments, the pitch change mechanism is operable to change a pitch angle of blades on the at least one fan blade during normal operational conditions.

In another embodiment according to any of the previous embodiments, the pitch change mechanism is also operable to move the at least one fan blade to a thrust reverser position at which it is configured to resist passage of air across the at least one fan blade to provide a thrust reversing function when an associated aircraft is landing.

In another embodiment according to any of the previous embodiments, the pitch change mechanism is operable to change an angle of the at least one blade by more than 90° during movement to the thrust reverser position.

In another embodiment according to any of the previous embodiments, the pitch change mechanism causes a shaft within a rotating housing to rotate to, in turn, change the pitch angle of the at least one blade.

In another embodiment according to any of the previous embodiments, a thrust reverser is associated with the outer shroud and is used in combination with the pitch change mechanism.

In another embodiment according to any of the previous embodiments, the core engine includes at least a pair of compressor rotors and at least a pair of turbine rotors. The fan turbine is a third turbine rotor.

In another embodiment according to any of the previous embodiments, the pitch change mechanism is operable to change an angle of the at least one blade by more than 90° during movement to the thrust reverser position.

In another embodiment according to any of the previous embodiments, the pitch change mechanism causes a shaft within a rotating housing to rotate to, in turn, change the pitch angle of the at least one blade.

In another embodiment according to any of the previous embodiments, a thrust reverser is associated with the outer shroud and is used in combination with the pitch change mechanism.

In another embodiment according to any of the previous embodiments, a thrust reverser is associated with the outer shroud and is used in combination with the pitch change mechanism.

In another embodiment according to any of the previous embodiments, a thrust reverser is provided in the outer shroud and is configured to be driven radially outwardly to provide a thrust reverser function when an aircraft associated with the gas turbine engine is landing.

In another embodiment according to any of the previous embodiments, the core engine includes at least a pair of compressor rotors and at least a pair of turbine rotors. The fan turbine is a third turbine rotor.

In another embodiment according to any of the previous embodiments, the core engine includes at least a pair of compressor rotors and at least a pair of turbine rotors. The fan turbine is a third turbine rotor.

In another embodiment according to any of the previous embodiments, an inlet to the core engine extends axially beyond an upstream end of the outer shroud.

These and other features may be best understood from the following drawings and specification.

### BRIEF DESCRIPTION OF THE DRAWINGS

FIG. 1 schematically shows a gas turbine engine.

FIG. 2 shows a detail of the gas turbine engine.

### DETAILED DESCRIPTION

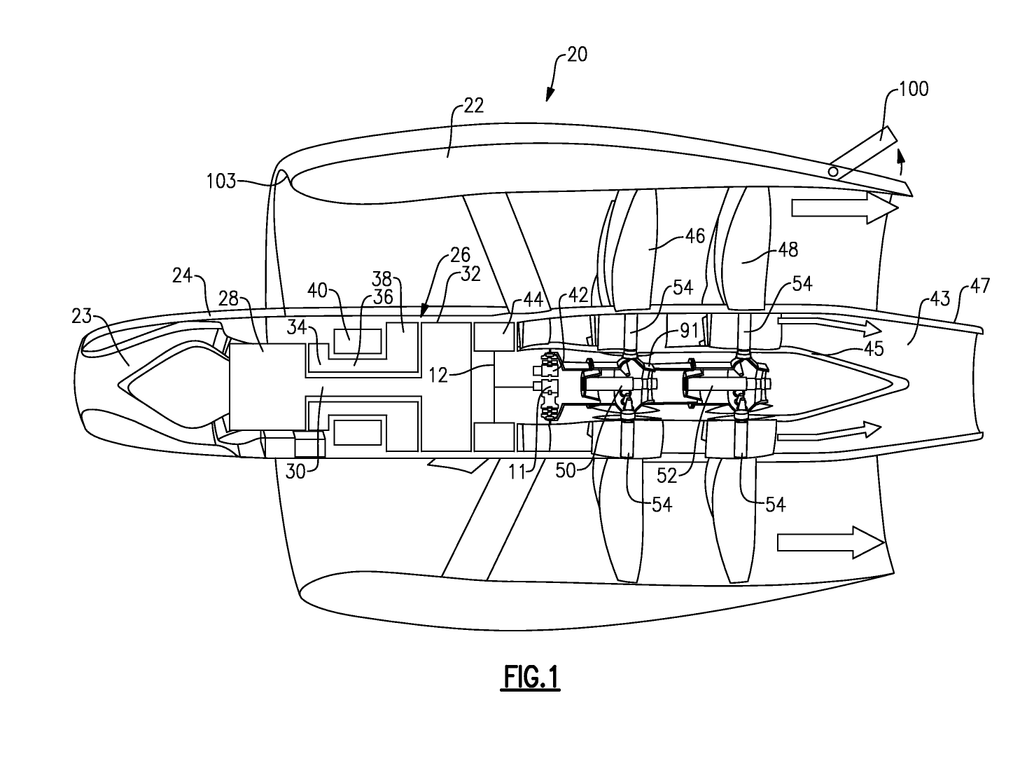

FIG. 1 shows a gas turbine engine 20 including an outer shroud 22. Bypass air is driven by a pair of fan rotors 46 and 48 within the shroud 22 and outwardly of the rotating housing 47. A core engine housing 24 is spaced inwardly of the shroud 22. Air passes into an inlet end 23 of the core housing 24 and then into a first compressor rotor 28. The first compressor rotor 28 is driven by a shaft 30 that is, in turn, driven by a low pressure turbine 32. Air from the first stage compressor 28 passes into a second stage compressor 34 which is driven by a shaft 36, in turn, driven by a turbine 38.

The air from the higher stage compressor rotor 34 passes into a combustion section 40 where it is mixed with fuel and ignited. Products of this combustion pass downstream over the turbine rotors 38 and 32 driving them to rotate. Collectively, the elements 28, 30, 32, 34, 36, 38 and 40 could be called a core engine 26. Products of the combustion downstream of the turbine rotor 32 pass over a fan drive turbine 44. The turbine 44 is aft or downstream of the turbine rotor 32. The turbine 44 drives a gear reduction 42 which may be a planetary gear reduction and which, in turn, drives shafts 50 and 52 to rotate the housing 47 and propeller blades 46 and 48. An outer housing 45 defines a core exhaust nozzle 43 with rotating housing 47. Inlet 23 to the core engine extends axially beyond an upstream end 103 of outer shroud 22.

A shell thrust reverser 100 is shown schematically which may pivot outwardly to provide a thrust reversal function when the engine 20 is mounted on an aircraft. The clamshell thrust reverser 100 is provided in outer shroud 22 and is driven radially outwardly to provide a thrust reverser function when an aircraft associated with the gas turbine engine is landing.

The propellers 46 and 48 are provided with pitch change mechanisms 91 that not only allow a slight change in pitch for different operational conditions of the engine 20, but also may allow a dramatic change in the pitch angle for thrust reversal purposes. As an example, while the normal operational pitch change range may be on the order of 10°, the pitch change mechanism may change the pitch angle by greater than 90° and on the order of 120° to provide a thrust reversing function.

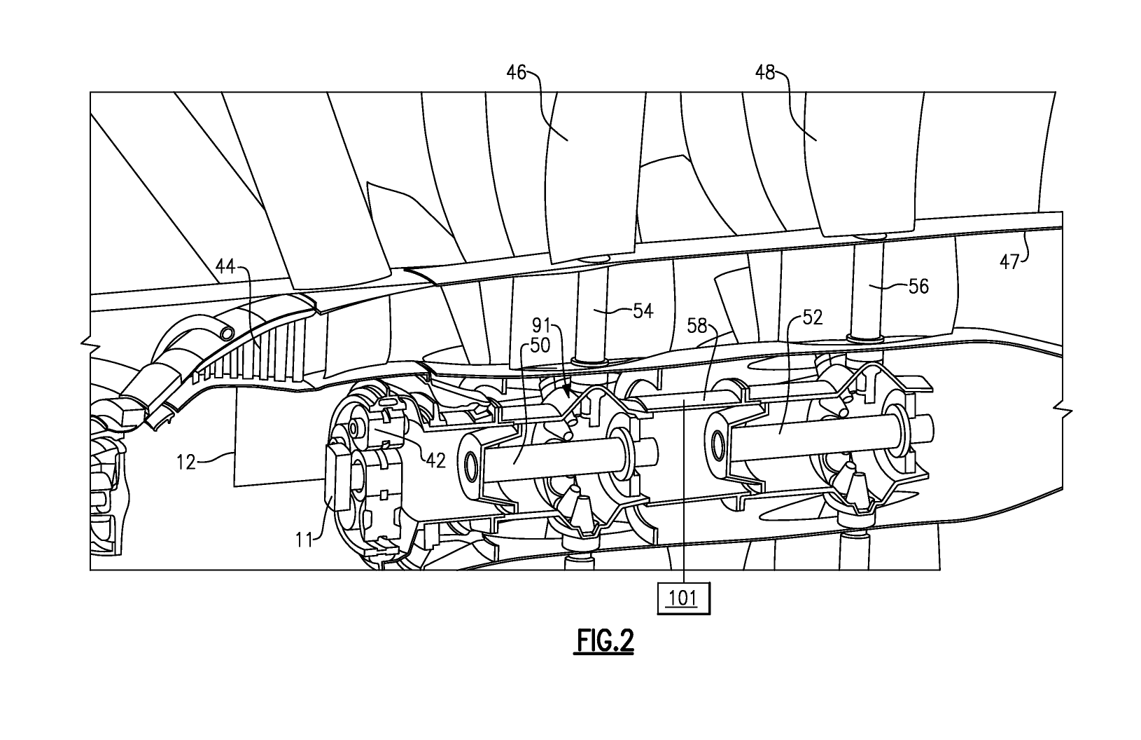

FIG. 2 shows details of the pitch change mechanism 91, including a shaft 54, a shaft 56 and the pitch change elements 58, which drive an angle of the shafts 54 and 56 to, in turn, change the angle of the blades 46 and 48.

A control 101 is shown schematically and is operable in conjunction with operation of the engine to actuate the pitch change mechanism 91, not only during operational conditions, but further to drive the propeller blades 46 and 48 to a thrust reversing position when an associated aircraft is landing. That is, the pitch change mechanism 91 also is operable to move fan blades 46/48 to a position at which they will resist passage of air across the fan blades 46/48 to provide a thrust reversing function when an associated aircraft is landing. This thrust reversing function can be utilized in combination with the clamshell thrust reverser 100 as shown schematically in FIG. 1, or as an alternative.

The propellers 44 and 46 are counter-rotating, meaning they rotate in opposed directions.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
an outer shroud;
an inner core housing positioned radially inwardly of said outer shroud, said inner core housing having a core engine including at least one compressor rotor and at least one turbine rotor, and a combustor section intermediate said at least one compressor rotor and said at least one turbine rotor; and
a fan turbine positioned downstream of said at least one turbine rotor, and said fan turbine for driving a gear reduction to, in turn, drive at least one fan blade positioned radially inwardly of said outer shroud.

2. The gas turbine engine as set forth in claim 1, wherein said at least one fan blade is a pair of axially spaced fan rotors.

3. The gas turbine engine as set forth in claim 2, wherein said pair of fan rotors rotate in opposed directions.

4. The gas turbine engine as set forth in claim 2, wherein said core engine includes at least a pair of compressor rotors and at least a pair of turbine rotors, and said fan turbine being a third turbine rotor.

5. The gas turbine engine as set forth in claim 4, wherein an inlet to said core engine extends axially beyond an upstream end of said outer shroud.

6. The gas turbine engine as set forth in claim 1, wherein a pitch change mechanism is associated with said at least one fan blade.

7. The gas turbine engine as set forth in claim 6, wherein said pitch change mechanism is operable to change a pitch angle of blades on said at least one fan blade during normal operational conditions.

8. The gas turbine engine as set forth in claim 7, wherein said pitch change mechanism is also operable to move said at least one fan blade to a thrust reverser position at which it is configured to resist passage of air across said at least one fan blade to provide a thrust reversing function when an associated aircraft is landing.

9. The gas turbine engine as set forth in claim 8, wherein said pitch change mechanism being operable to change an angle of said at least one blade by more than 90° during movement to said thrust reverser position.

10. The gas turbine engine as set forth in claim 9, wherein said pitch change mechanism causing a shaft within a rotating housing to rotate to, in turn, change the pitch angle of the at least one blade.

11. The gas turbine engine as set forth in claim 10, wherein a thrust reverser is associated with said outer shroud and is used in combination with said pitch change mechanism.

12. The gas turbine engine as set forth in claim 1, wherein said core engine includes at least a pair of compressor rotors and at least a pair of turbine rotors, and said fan turbine being a third turbine rotor.

13. The gas turbine engine as set forth in claim 6, wherein said pitch change mechanism being operable to change an angle of said at least one blade by more than 90° during movement to said thrust reverser position.

14. The gas turbine engine as set forth in claim 13, wherein said pitch change mechanism causing a shaft within a rotating housing to rotate to, in turn, change the pitch angle of the at least one blade.

15. The gas turbine engine as set forth in claim 13, wherein a thrust reverser is associated with said outer shroud and is used in combination with said pitch change mechanism.

16. The gas turbine engine as set forth in claim 12, wherein a thrust reverser is associated with said outer shroud and is used in combination with said pitch change mechanism.

17. The gas turbine engine as set forth in claim 1, wherein a thrust reverser is provided in said outer shroud and is configured to be driven radially outwardly to provide a thrust reverser function when an aircraft associated with the gas turbine engine is landing.

18. The gas turbine engine as set forth in claim 17, wherein said core engine includes at least a pair of compressor rotors and at least a pair of turbine rotors, and said fan turbine being a third turbine rotor.

19. The gas turbine engine as set forth in claim 6, wherein said core engine includes at least a pair of compressor rotors and at least a pair of turbine rotors, and said fan turbine being a third turbine rotor.

20. The gas turbine engine as set forth in claim 1, wherein an inlet to said core engine extends axially beyond an upstream end of said outer shroud.
